(19) United States
(12) Patent Application Publication
(10) Pub. No.: US 2006/0020454 A1
(43) Pub. Date: Jan. 26, 2006

(54) Method and system for noise suppression in inductive receivers

(75) Inventor: Louis Gerber, Bern (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 10/896,620

(22) Filed: Jul. 21, 2004

(51) Int. Cl. G10L 15/20

(52) U.S. Cl. 704/233

(57) ABSTRACT

A method for noise suppression in wireless receivers or hearing aid devices comprising a receiver coil, wherein audible information is transmitted from a transmitter coil or loop in a wireless manner to said receiver coil, is disclosed and claimed. The method includes that the signal received by said receiver coil is analyzed by digital signal processing in the hearing frequency range and/or the speaking time range for discrete noise signals and other sound artifacts, and said noise signals and other sound artifacts are removed from said signal. This method allows to suppress noise that is introduced into the speech signal during the inductive transmission.

This invention belongs to the field of electromagnetic wave transmission and is in particular related to the wireless transmission of audible information by inductive devices.

Wireless communication receivers of audible information have already been known. One well-known device is a wireless miniature communication receiver called “Phonito®”, developed and distributed by the Applicant. Such receivers are inductively coupled wireless earphones. Users who do not want to have a wire or an acoustic tube going to the ear, or users where such a wire or tube cannot be tolerated, can attach an inductive loop that may be worn around the neck under a garment such as jacket or uniform, or the inductive loop or coil can be integrated into the clothing. The inductive loop sends the information to be heard that has been transformed into the appropriate inductive transmission form, to the earphone where it is received and re-transformed into acoustic waves. The receiver worn in connection with the inductive loop and which provides speech information may be a mobile radio such as e.g. a portable citizen's band (CB) receiver, a portable telephone or any other information source that is capable of receiving wireless or broadcast information.

The miniaturized ITE (in-the-ear) devices and/or BTE (behind-the-ear) devices considered in this document are being used since several years in the field of security and police, in acoustic studios, for sport applications, and in any other field where the presence of an acoustic communication should be kept discreet or secret. These devices are working based on the principle of inductive signal transmission and reception.

An audio signal U(t) that is generated at the output of a sound device such as a mobile radio receiver, a portable or fixed telephone, etc., is transmitted via an appropriate amplifier into a closed wire loop or an inductive coil. Of course, if a coil is used, it will preferably be miniaturized. This loop or coil that is typically worn by the user will generate a magnetic field whose field intensity H(t) is correlated to the original signal U(t). In most cases, this correlation is a proportional one or a simple mathematical function of the original signal. There are also devices based on inductive transmissions that are digital or frequency modulated.

Common features of all these devices and appliances based on inductive transmission is the fact that their transmission distance is relatively short, and that their signal-to-noise ratio, where the noise comes mainly from external sources, is low. These features make the devices relatively insensitive to noise fields and interception in comparison to RF (radio frequency) receivers.

In spite of the short interference and noise distance that is only some meters distant from a source of interference and noise fields, the number of these sources has considerably increased within the last years so that they become more and more a problem even for short-distant inductive transmissions. For example, such new and increasing interference sources are low frequency devices such as aerial conduct lines of electric trains, tramways and trolley buses; low voltage transformers for lighting purposes and their connecting and power lines that typically carry high amperages; computer monitors; inductive security systems such as tags, theft warning installations, security warn systems in casinos, banks, postal offices, etc.; electronic systems in automotive vehicles; and mobile telephones which produce the so-called 300 Hz noise. All these low frequency noise generators directly interfere with the reception field of the inductor. The consequence of this interference is a hum or still another noise that has a detrimental effect on the integrity of the signal and thus on the quality of the displayed audio signal.

This problem of low frequency interference has already been addressed by introducing correction systems based on AGC (Automatic Gain Control) and squelch management. Furthermore, since the frequencies to be transmitted nearly exclusively are speech (voice) frequencies, it is possible to improve the quality of the transmission, i.e. remove noise (hum), by low pass and/or high pass filters in order to limit the spectrum of useful frequencies in the low and high ranges.

These solutions do bring about significant improvements with respect to inductors devoid of any interference and noise diminution or suppression. In particular, the squelch function avoids the reception and generation of audible disturbances when no voice signal is transmitted, i.e. in speaking pauses.

Nevertheless, the systems now available, even the very sophisticated ones, do not produce a satisfactory signal quality in particularly severe environments.

Accordingly, the invention aims at providing a new and useful solution to the problem of low frequency disturbances, interference and noise in inductive transmission systems of the kind described above. The invention therefore concerns a method for noise suppression in inductive receivers.

This objective is attained by the method of the invention that is defined in the first independent claim. A system for implementing the method of the invention is the subject of the second independent claim. Further preferred embodiments follow moreover from the dependent claims and from the description.

It should be stated here that, besides the method according to the invention, the present invention also relates to a system for carrying out the method.

In particular the objects are achieved through the invention in that an inductive receiver comprises a receiver coil, wherein audio information is transmitted from a transmitter coil or loop in a wireless manner to said receiver coil, wherein the signal received by said receiver coil is analyzed by digital signal processing in the hearing frequency range and/or the speaking time range for discrete noise signals and other sound artifacts, and said noise signals and other sound artifacts are removed from said signal. A DSP (Digital Signal Processing) module can e.g. manipulate analog information, such as e.g. sound that has been converted into a digital form. DSP can e.g. also comprise the use of a data compression technique. A DSP element can comprise a digital signal processor, i.e. a specialized type of processor designed for performing the mathematics involved in DSP. The DSPs can be programmable, which means that they can be used for manipulating different types of information, including e.g. sound, images, and video. Said noise can e.g. be a low frequency noise in the range of from 50 Hz to 4-8 kHz. An audio signal is restored after the removal of said noise signals and other sound artifacts. The analysis of the received signal and/or the restoration of said signal and/or the removal of said noise signals and other sound artifacts can be accomplished by the use of at least one algorithm of acoustic speech processing. Said at least one algorithm of acoustic speech processing can be selected from algorithms based on the principles of speech theory. Said algorithm can e.g. comprise a Wiener filtering method

Embodiment variants of the present invention will be described in the following with reference to examples.

FIG. 1 shows a spectrum illustrating schematically an excitation signal of a human vocal and articulation tract. The properties of resonance of the articulation tract affect the excitation signal in such a way that certain frequency ranges are passed and/or amplified and others are suppressed. The passed frequencies F₁, F₂, F₃ and F₄ are usually called formant frequencies. Formants F₁, F₂, F₃ and F₄ are important to create the voiced sounds. The formants F₁, F₂, F₃ and F₄ can have a great importance in relation to noise suppression. FIG. 1 shows the voice spectrum of a spoken /i/.

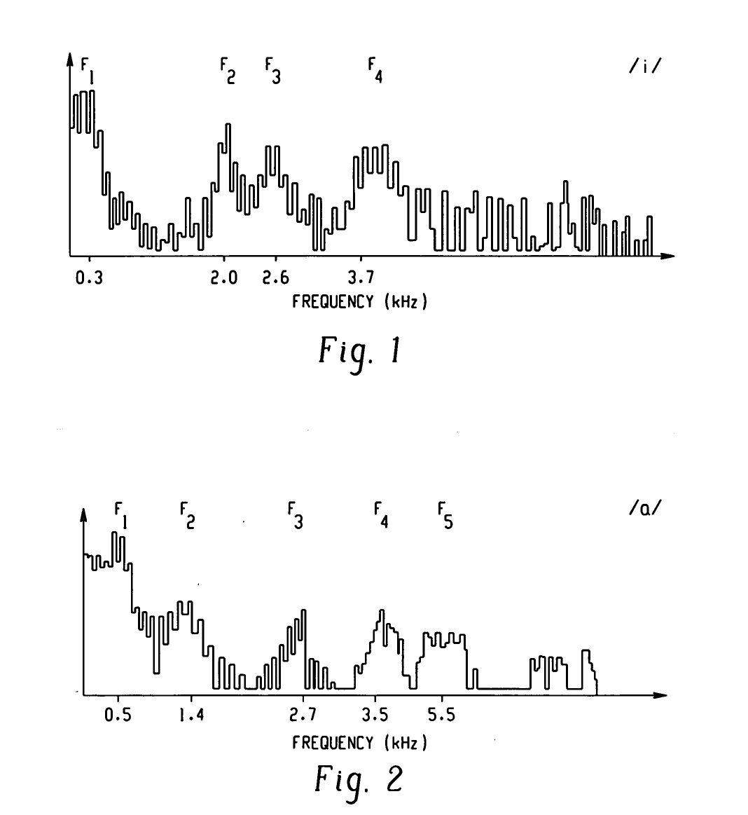

FIG. 2 shows another spectrum illustrating schematically an excitation signal of a human vocal and articulation tract. The formants here are F₁, F₂, F₃, F₄ and F₅, showing the voice spectrum of a spoken /a/.

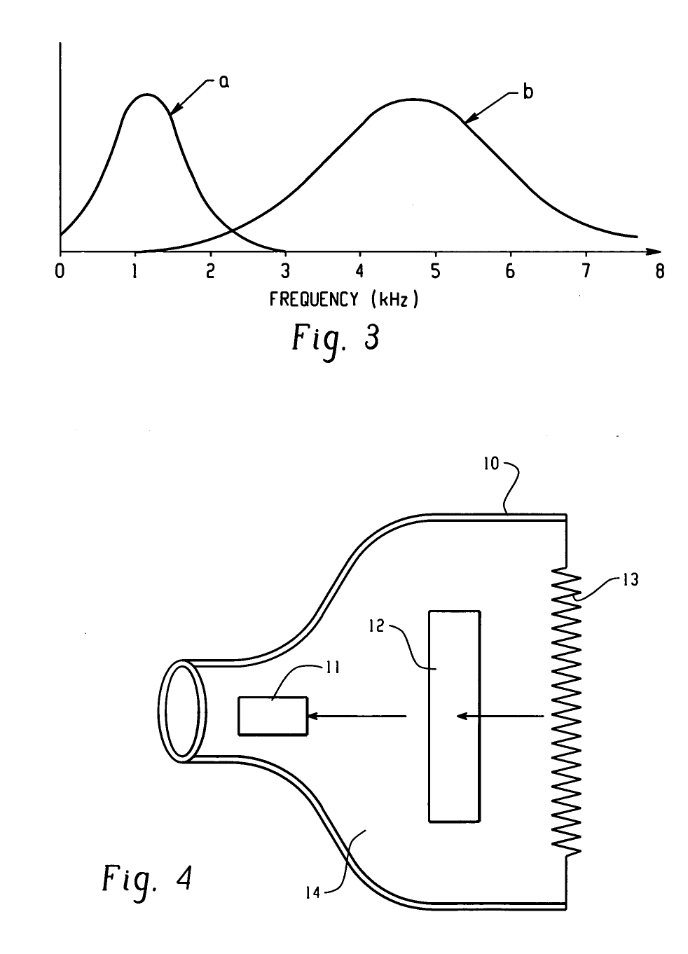

FIG. 3 shows the energy spectrum for voiced (a) and unvoiced (b) sounds of the human voice. The fundamental frequency of men's voices is typically around 80 Hz, whereas children's voices typically show a fundamental frequency of around 330 Hz.

FIG. 4 shows a schematic diagram which illustrates an architecture which may be used for carrying out the invention. The reference numeral 10 is an inductive receiver, 11 is a loud speaker, 12 is a DSP (Digital Signal Processing) module, 13 is an inductive element such as e.g. a coil and 14 is a cavity of the inductive receiver 10 to comprise the mentioned elements.

Thus, the method of the invention uses algorithms to implement the restoration of the original speech signals by analyzing the spectrum and the dynamics of the received, noisy or disturbed signal according to principles based on the theory of speech.

Acoustic noise cancellation methods, as far as they are already known, are based on several algorithms or treatment processes.

Examples of such methods for Audio Noise Reduction are: (1) noise reduction by spectral weighting, (2) noise reduction using coherent properties, (3) noise cancellation using Wiener filtering in the frequency domain, (4) directive beam forming, and still others.

In method (1), different spectral regions of the mixed signal of speech and noise are attenuated with different factors. One obtains an audio signal that contains less noise than the original one. The spectral weighting is usually performed in a transformation domain; a common transformation is the Fourier transformation which provides an equidistant frequency resolution. Alternatively, one may use the wavelet transform that yields a non-equidistant spectral resolution. Details are known to the one skilled in the art of audio frequency correction techniques.

In method (2), acoustic noise is reduced by a Generalized Sidelobe Canceller (GSC) that reasonably suppresses the coherent noise components while a Wiener filter (see below) is designed to suppress the spatial incoherent noise components.

According to method (3), the Wiener filtering method is based on minimizing the mean square error between the speech S(f) and the estimate Y(f) where the fact may be used that speech and noise are statistically not correlated.

Method (4), directive beam forming, refers to speech recognition and/or extraction form noise and uses a microphone array of which the different microphones can e.g. detect the phase difference and/or time of flight (tof) of the incoming signal. The beamforming can e.g. seek to exploit the phase differences between microphone signals before combining the outputs of the microphones to restore the original speech.

Still more proposals have been made to treat noise (i.e. to reduce, minimize or suppress it) in audio signals, i.e. analog, amplitude modulated waveforms. An application to the noise reduction as provided by the invention has not become known so far. The invention is not limited to a special processing algorithm.

The method of the invention may be implemented in using electronic components already known per se. The received signal is digitized in an A/D converter, is analyzed e.g. by algorithms being adapted to speech patterns and/or by comparison with stored speech patterns, discrete noise signals and clearly distinguishable artifacts are filtered out using at least one stored algorithm, and the purified digital signal is sent to the earphone or earplug. If necessary or required, the digital output can be re-transformed to analog signals.

According to a particular embodiment of the invention, the method and the corresponding system are designed for preferably removing low frequency noise, in particular between 50 Hz and 4-8 kHz, taking into consideration that a great deal of disturbing and interfering noise originates from this frequency range. This noise can be e.g. in the form of sinusoidal signals or set of harmonics that may also be amplitude modulated. As example can serve the 900 MHz GSM (Global System for Mobile Communications) radio frequency signal which is switched at a rate of 300 Hz.

The invention allows to drastically improve the quality of wireless speech and voice transmission by induction. Furthermore, additional application fields are opened to inductive speech transmission. It is even conceivable to transmit also, additionally or alternatively, sound and music with an improved quality.

Numerous modifications, variations and developments are accessible to the one skilled in the art. Thus, the nature of algorithms to be used and of the required electronic, inductive and acoustic components is left to the best knowledge of those ordinarily skilled in the art.

1. A method for noise suppression in inductive receivers comprising a receiver coil, wherein audio information is transmitted from a transmitter coil or loop in a wireless manner to said receiver coil, the method being characterized in that the signal received by said receiver coil is analyzed by digital signal processing in the hearing frequency range and/or the speaking time range for discrete noise signals and other sound artifacts, and said noise signals and other sound artifacts are removed from said signal.

2. The method according to claim 1, wherein said noise is a low frequency noise in the range of from 50 Hz to 4-8 kHz.

3. The method according to claim 1, wherein an audible signal is restored after the removal of said noise signals and other sound artifacts.

4. The method according to one of the claims 1 or 3, wherein said analysis of the received signal and/or the restoration of the received signal and/or the removal of said noise signals and other sound artifacts is accomplished by the use of at least one algorithm of acoustic speech processing.

5. The method according to claim 4, wherein said at least one algorithm of acoustic speech processing is selected from algorithms based on the principles of speech theory.

6. The method according to claim 4, wherein said algorithm is a Wiener filtering method.

7. A system for noise suppression in wireless receivers comprising a receiver coil, wherein audible information is transmitted from a transmitter coil or loop in a wireless manner to said receiver coil, characterized by the fact that the system comprises means for analyzing the received signal by digital signal processing, means for identifying discrete noise signals and other sound artifacts, means for removing said discrete noise signals and other sound artifacts, and means for restoring the undisturbed original speech.

8. The system according to claim 7, wherein said means for analyzing the received signal are adapted to analyze the signal in the hearing frequency range and/or the speaking time range.

9. The system according to one of the claims 7 or 8, further comprising means for storing algorithms for analyzing, removing and restoring.
